(19) United States
(12) Patent Application Publication
(10) Pub. No.: US 2023/0319757 A1
(43) Pub. Date: Oct. 5, 2023

(54) METHOD AND DEVICE FOR PROVIDING ACCESS PATH IN WIRELESS COMMUNICATION SYSTEM

(71) Applicant: SAMSUNG ELECTRONICS CO., LTD., Suwon-si (KR)

(72) Inventors: Dongyeon KIM, Suwon-si (KR); Dongeun SUH, Suwon-si (KR)

(21) Appl. No.: 18/192,534

(22) Filed: Mar. 29, 2023

(30) Foreign Application Priority Data
Mar. 29, 2022 (KR) 10-2022-0038572
May 6, 2022 (KR) 10-2022-0056133

(51) Int. Cl. H04W 60/04; H04W 76/10; H04W 76/30

(52) U.S. Cl. CPC H04W 60/04; H04W 76/10; H04W 76/30

(57) ABSTRACT

The disclosure relates to a fifth generation (5G) or sixth generation (6G) communication system for supporting a higher data transmission rate. According to the disclosure, an operation method of a UE in a wireless communication system includes transmitting a registration request message including an access traffic steering, switching, splitting (ATSSS) path switching indication to a target access network entity, receiving a registration accept message including an access path switching timer value from the target access network entity, in response to the registration request message, transmitting a packet data unit (PDU) session establishment request message to an access and mobility management function (AMF) via the target access network entity, based on the access path switching timer value, and releasing a PDU session with a source access network entity.

### CROSS-REFERENCE TO RELATED APPLICATIONS

This application is based on and claims priority under 35 U.S.C. § 119 to Korean Patent Application Nos. 10-2022-0038572 and 10-2022-0056133, filed on Mar. 29, 2022, and May 6, 2022, in the Korean Intellectual Property Office, the disclosure of which are herein incorporated by reference in their entirety.

### BACKGROUND

### 1. Field

The disclosure relates to a device and method for providing an access path in a wireless communication system or a mobile communication system and, more specifically, to a method and device for providing access traffic steering, switching, splitting (ATSSS) functionality in a wireless communication system.

### 2. Description of Related Art

Fifth generation (5G) mobile communication technologies define broad frequency bands such that high transmission rates and new services are possible, and can be implemented not only in “Sub 6 gigahertz (GHz)” bands, such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz bands (for example, 95 GHz to 3 terahertz (THz) bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input-multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

In a 5G system, when a UE uses a PDU session, connection via only one access path per access network type (3GPP access, non-3GPP access) may be possible between the UE and a 5G core network. In addition, one UE may have only one registration management state and one connection management state per access network type in the 5G core network. Therefore, when switching from one access path to another access path is required in case in which a UE is using a multi-access protocol data unit (MA PDU) session via multiple access paths, a new access path may not be added without deregistration and session release with respect to the access path to be switched.

Therefore, the disclosure provides a method and device for providing access path switching without session release and deregistration with respect to a UE when the UE is using a session via multiple access paths in a 5G system.

According to the disclosure, an operation method of a UE in a wireless communication system includes transmitting a registration request message including an access traffic steering, switching, splitting (ATSSS) path switching indication to a target access network entity, receiving a registration accept message including an access path switching timer value from the target access network entity, in response to the registration request message, transmitting a packet data unit (PDU) session establishment request message to an access and mobility management function (AMF) via the target access network entity, based on the access path switching timer value, and releasing a PDU session with a source access network entity.

According to the disclosure, an operation method of an AMF in a wireless communication system includes receiving a registration request message including an access traffic steering, switching, splitting (ATSSS) path switching indication from a UE via a target access network entity, when an ATSSS path is switchable based on the registration request message, transmitting a PDU session update request message indicating an ATSSS path switching indication, a radio access technology (RAT) type of the target access network, and a RAT type of a source access network to a session management function (SMF), receiving an update response message including an access path switching timer value from the SMF in response to the PDU session update request message, transmitting a registration accept message including the access path switching timer value to the UE via the target access network, based on the update response message, and receiving a PDU session establishment request message from the UE via the target access network entity in response to the registration accept message.

According to the disclosure, an operation method of an SMF in a wireless communication system includes receiving a PDU session update request message indicating an ATSSS path switching indication of a UE, a RAT type of a target access network, and a RAT type of a source access network from an AMF, transmitting a PDU session update response message including an access path switching timer value to the AMF, in response to the PDU session update request message, receiving a PDU session create request message from the AMF in response to the PDU session update response message, and terminating a PDU session of the UE with respect to the source access network, based on the PDU session create request message.

According to the device and method according to the disclosure, when a UE uses a service by using a 5G core network and a multi-access protocol data unit (MA PDU) session in a wireless communication system, an access path may be switched without deregistration and session release with respect to the UE.

Advantageous effects obtainable from the disclosure may not be limited to the above-mentioned effects, and other effects which are not mentioned may be clearly understood, through the following descriptions, by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a 5G system structure according to embodiments of the present disclosure;

FIG. 2 illustrates a 5G system structure for ATSSS functionality support according to embodiments of the present disclosure;

FIGS. 3A to 3C illustrate a flowchart of a method for switching an access path in a wireless communication system and a procedure related thereto according to embodiments of the present disclosure;

FIGS. 4A to 4D illustrate a flowchart of a method for switching an access path of a UE 10 in a wireless communication system and a procedure related thereto according to embodiments of the present disclosure;

FIGS. 5A to 5D illustrate a flowchart of a method for switching an access path of a UE in a wireless communication system and a procedure related thereto according to embodiments of the present disclosure;

FIG. 6 illustrates a UE in a wireless communication system according to embodiments of the present disclosure;

FIG. 7 illustrates an NG-RAN in a wireless communication system according to embodiments of the present disclosure;

FIG. 8 illustrates a source access network in a wireless communication system according to embodiments of the present disclosure;

FIG. 9 illustrates a target access network in a wireless communication system according to embodiments of the present disclosure:

FIG. 10 illustrates an AMF in a wireless communication system according to embodiments of the present disclosure;

FIG. 11 illustrates an SMF in a wireless communication system according to embodiments of the present disclosure;

FIG. 12 illustrates a UPF in a wireless communication system according to embodiments of the present disclosure;

FIG. 13 illustrates a PCF in a wireless communication system according to embodiments of the present disclosure;

FIG. 14 illustrate a UDM in a wireless communication system according to embodiments of the present disclosure; and

FIG. 15 illustrates a DN in a wireless communication system according to embodiments of the present disclosure.

### DETAILED DESCRIPTION

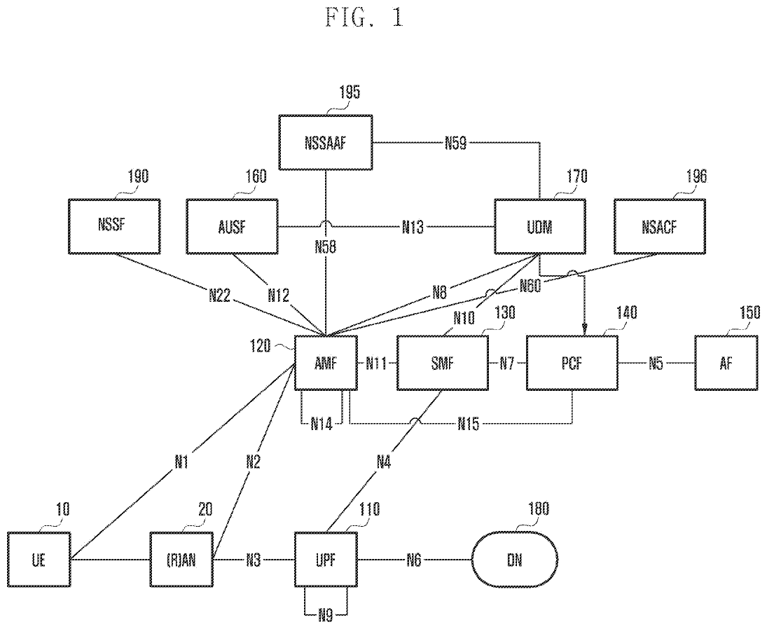

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card. Moreover, the “unit” in the embodiments may include one or more processors.

In the following description of the disclosure, a detailed description of known functions or configurations incorporated herein will be omitted when it is determined that the description may make the subject matter of the disclosure unnecessarily unclear. Hereinafter, embodiments of the disclosure will be described in detail with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description, the disclosure will be described using terms and names defined in in the 3rd generation partnership project long term evolution (3GPP LTE) standards for the sake of descriptive convenience. However, the disclosure is not limited by these terms and names, and may be applied in the same way to systems that conform other standards. In the disclosure, the term “eNB” may be interchangeably used with the term “gNB.” That is, a base station described as “eNB” may indicate “gNB.” In addition, the term “terminal” may refer to not only mobile phones, NB-IoT devices, and sensors, but also any other wireless communication devices.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. Of course, examples of the base station and the terminal are not limited thereto.

In particular, the disclosure may be applied to 3GPP NR (5th generation mobile communication standard). The disclosure may be applied to intelligent services (e.g., smart homes, smart buildings, smart cities, smart cars or connected cars, healthcare, digital education, retail business, security and safety-related services, etc.) on the basis of 5G communication technology and IoT-related technology. In the disclosure, the term “eNB” may be interchangeably used with the term “gNB.” That is, a base station described as “eNB” may indicate “gNB.” In addition, the term “terminal” may refer to not only mobile phones, NB-IoT devices, and sensors, but also any other wireless communication devices.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)}, LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE) (or a mobile station (MS)) transmits data or control signals to a base station (BS) (generation Node B (gNB) or eNode B (eNB)), and the downlink indicates a radio link through which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a post-LTE communication system, that is, 5G communication system must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to some embodiments, eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, the Internet of Things must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and may also require a design for assigning a large number of resources in a frequency band in order to secure reliability of a communication link.

The above described three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. However, the above-described mMTC, URLLC, and eBB are merely an example of different service types, and service types to which the disclosure is applied are not limited thereto.

Furthermore, in the following description of embodiments of the disclosure, an LTE, LTE-A, LTE-Pro, or NR system will be described by way of example, but the embodiments of the disclosure may be applied to other communication systems having similar backgrounds or channel types. In addition, based on determinations by those skilled in the art, the embodiments of the disclosure may be applied to other communication systems through some modifications without significantly departing from the scope of the disclosure.

The terms which will be described below are terms defined in consideration of the functions in the disclosure, and may be different according to users, intentions of the users, or customs. Therefore, the definitions of the terms should be made based on the contents throughout the specification.

Hereinafter, exemplary embodiments of the disclosure will be described in detail with reference to the accompanying drawings. It should be noted that, in the drawings, the same or like elements are designated by the same or like reference signs as much as possible. Also, it should be noted that the accompanying drawings of the disclosure are provided to assist in understanding the disclosure, and the disclosure is not limited by the shapes or arrangements illustrated in the drawings. Furthermore, a detailed description of known functions or configurations that may make the subject matter of the disclosure unclear will be omitted. It should be noted that, in the following description, only parts required to understand operations according to various embodiments will be described and a description of the other parts will be omitted so as not to make the subject matter of the disclosure obscure. Moreover, in the description of various embodiments of the disclosure, terms employed in some communication standards (e.g., the 3rd generation partnership project (3GPP)) will be illustratively used for the sake of description. Various embodiments of the disclosure may also be easily applied to other communication systems through modifications.

FIG. 1 illustrates a structure of a 5G system according to embodiments of the present disclosure.

Referring to FIG. 1, the structure of a 5G system may include various components (i.e., a network function (NF)). FIG. 1 illustrates an authentication server function (AUSF) device 160, a (core) access and mobility management function (AMF) device 120, a session management function (SMF) device 130, a policy control function (PCF) device 140, an application function (AF) device 150, a unified data management (UDM) device 170, a data network (DN) 180, a user plane function (UPF) device 110, (radio) access network ((R)AN) 20, a terminal, that is, a user equipment (UE) 10, which corresponds to some of the components. In addition, FIG. 1 illustrates a network slice selection function (NSSF) device 190, a network slice specific authentication and authorization function (NSSAAF) device 195, and a network slice admission control function (NSACF) device 196.

Each of the devices illustrated in FIG. 1 may be implemented as one server or device, and may be implemented as a network slice instance as described above. When implemented as a network slice instance, two or more identical or different network slice instances may be implemented in one server or device, and one network slice instance may be implemented in two or more servers or devices.

Each of the above NFs may support the following functions.

The AUSF 160 may process and store data for authentication of the UE 10.

The AMF 120 may provide functions for access and mobility management in units of UEs, and each UE may be basically connected to one AMF. Specifically, the AMF 120 may support functions, such as CN inter-node signaling for mobility between 3GPP access networks, termination of a radio access network (RAN) CP interface (i.e., N2 interface), termination of NAS signaling (N1), NAS signaling security (NAS ciphering and integrity protection), AS security control, registration management (registration area management), connection management, idle mode UE reachability (including control and performance of paging retransmission), mobility management control (subscriptions and policies), support for intra-system mobility and inter-system mobility, support for network slicing, SMF selection, lawful intercept (for interfaces to AMF events and LI systems), transport and provision for session management (SM) messages between the UE and the SMF, transparent proxy for SM message routing, access authentication, access authorization including roaming authorization check, transport and provision for SMS messages between the UE and short message service function (SMSF), security anchor function (SAF), and/or security context management (SCM). Some or all functions of the AMF 120 may be supported within a single AMF instance operating as one AMF.

The DN 180 may refer to, for example, an operator service, Internet access, or a third party service. The DN 180 may transmit a downlink protocol data unit (PDU) to the UPF 110 or may receive a PDU transmitted from the UE 10 via the UPF 110.

The PCF 140 may receive packet flow information from an application server and provide a function of determining policies, such as mobility management and session management. Specifically, the PCF 140 may support functions of supporting a unified policy framework to govern network operation, providing policy rules to enable control plane function(s) (e.g., AMF, SMF, etc.) to enforce the policy rules, and implementing a front end to access relevant subscription information for policy decisions in a user data repository (UDR).

The SMF 130 may provide a session management function, and when the UE has multiple sessions, each session may be managed by a different SMF. Specifically, the SMF 130 may support functions, such as session management (e.g., session establishment, modification and termination including maintaining tunnels between a UPF and an AN node), UE IP address allocation and management (optionally including authentication), selection and control of UP functions, configuration of traffic steering to route traffic to appropriate destinations in UPF, termination of interface toward policy control function, control part of policy enforcement and quality of service (QoS), lawful intercept (for interfaces to SM events and LI systems), termination of SM part of a NAS message, downlink data notification, initiator of AN-specific SM information (transmission to AN through N2 via AMF), SSC mode determination of a session, and a roaming function. As described above, some or all functions of the SMF 130 may be supported within a single SMF instance operating as one SMF.

The UDM 170 may store user subscription data, policy data, and the like. The UDM 170 may include two parts, i.e., an application front end (FE) (not shown) and a user data repository (UDR) (not shown).

The FE may include a UDM FE in charge of location management, subscription management, credential processing, and the like, and a PCF-FE in charge of policy control. The UDM 170 may store data required for functions provided by the UDM-FE and a policy profile required by the PCF. Data stored in the UDR may include policy data and user subscription data including a subscription identifier, security credential, access and mobility related subscription data, and session related subscription data. UDM-FE may access subscription information stored in the UDR and support functions, such as authentication credential processing, user identification handling, access authentication, enrollment/mobility management, subscription management, and SMS management.

The UPF 110 may transmit the downlink PDU received from the DN 180 to the UE 10 via the (R) AN 20, and transmit the uplink PDU received from the UE 10 via the (R) AN 20 to the DN 180. Specifically, the UPF 110 may support anchor point for intra/inter RAT mobility, external PDU session point of interconnection to data network, packet routing and forwarding, packet inspection and user plane part of policy rule enforcement, lawful intercept, traffic usage reporting, uplink classifier to support routing of traffic flows to a data network, branching point to support multi-homed PDU sessions, QoS handling for user plane (e.g., packet filtering, gating, uplink/downlink rate enforcement), uplink traffic verification (service data flow (SDF) to QoS flow mapping), transport level packet marking in uplink and downlink, downlink packet buffering, and downlink data notification triggering function. Some or all functions of the UPF 110 may be supported within a single UPF instance operating as one UPF.

The AF 150 may interact with the 3GPP core network to provide services (e.g., support functions, such as application influence on traffic routing, access to network capability exposure, and interaction with policy framework for policy control).

The (R)AN 20 may collectively refer to a new radio access network supporting both evolved E-UTRA, an evolved version of 4G radio access technology, and new radio (NR) (e.g., gNB).

The gNB 20 may support functions, such as functions for radio resource management (i.e., radio bearer control), radio admission control, connection mobility control, dynamic allocation of resources (i.e., scheduling) to the UE 10 in uplink/downlink, internet protocol (IP) header compression, encryption and integrity protection of user data streams, selection of the AMF 120 at attachment of the UE 10 when routing to the AMF 120 is not determined from information provided to the UE 10, user plane data routing to the UPF(s) 110, control plane information routing to AMF 120, connection setup and termination, scheduling and transmission of paging messages (generated from the AMF 120), scheduling and transmission of system broadcast information (generated from the AMF 120 or operating and maintenance (O&M)), measurements and measurement reporting configuration for mobility and scheduling, transport level packet marking in uplink, session management, support for network slicing, QoS flow management and mapping to data radio bearers, support of the UE 10 in inactive mode, distribution function of NAS messages, NAS node selection function, wireless access network sharing, dual connectivity, and tight interworking between NR and E-UTRA.

The UE 10 may refer to a user device. The user device may be referred to as a terminal, a mobile equipment (ME), or a mobile station (MS). In addition, the user device may be a portable device, such as a laptop computer, a mobile phone, a personal digital assistant (PDA), a smartphone, and a multimedia device, or may be a non-portable device, such as a personal computer (PC) and a vehicle-mounted device. Hereinafter, description will be given by referring to a user equipment (UE) or a terminal.

For clarity of explanation, a network exposure function (NEF) device and an NF repository function (NRF) device are not shown in FIG. 1, but NFs may interact with NEF and NRF as needed.

The NRF (not shown in FIG. 1) may support a service discovery function. When second NF discovery request is received from a first NF instance, the NRF may provide information on the second NF instance discovered after performing second NF discovery operation to the first NF instance. In addition, the NRF may maintain available NF instances and the services supported thereby.

For convenience of description, FIG. 1 illustrates a reference model for a case in which the UE 10 accesses one DN 180 by using one PDU session, but the disclosure is not limited thereto.

The UE 10 may access two (i.e., local and central) data networks simultaneously by using multiple PDU sessions. At this time, two SMFs may be selected for different PDU sessions. However, each SMF may have the ability to control both the local UPF and the central UPF within the PDU sessions.

Additionally, UE 10 may simultaneously access two (i.e., regional and centralized) data networks provided within a single PDU session.

In the 3GPP system, a conceptual link connecting NFs in the 5G system is defined as a reference point. The following illustrates reference points included in the structure of the 5G system illustrated in FIG. 1:
N1: Reference point between UE and AMF;
N2: Reference point between (R)AN and AMF;
N3: Reference point between (R)AN and UPF;
N4: Reference point between SMF and UPF;
N5: Reference point between PCF and AF;
N6: Reference point between UPF and data network;
N7 Reference point between SMF and PCF;
N8: Reference point between UDM and AMF;
N9: Reference point between two core UPFs;
N10: Reference point between UDM and SMF;
N11: Reference point between AMF and SMF;
N12: Reference point between AMF and AUSF;
N13: Reference point between UDM and authentication server function (AUSF);
N14: Reference point between two AMFs; and
N15: Reference point between PCF and AMF in case of non-roaming scenario, reference point between PCF and AMF in visited network in case of roaming scenario.

In the following description, the terminal may refer to the UE 10, and the terms UE and terminal may be used interchangeably. In this case, the terminal should be understood as the UE 10 unless the terminal is additionally defined.

A UE may access a data network (e.g., a network providing Internet service) via the 5G system to establish a session, and may distinguish each data network by using an identifier called a data network name (DNN). The DNN may be used to determine NFs related to a user plane, interfaces between NFs, and operator policies when the UE connects a network system and a session. The DNN may be used, for example, to select SMF and UPF(s) for a PDU session, and may be used to select an interface(s) (e.g., N6 interface) between a data network and a UPF for a PDU session. In addition, the DNN may be used to determine a mobile communication operator policy to apply to a PDU session.

The ATSSS functionality refers to functionality for transporting data traffic via one or more accesses by utilizing both the above-described 3GPP access and/or non-3GPP access between the UE and the 5G core network. A representative example of the ATSSS functionality may include a case in which when the 5G core network determines that user plane resources between the UE and the data network (DN) 180 are insufficient or that load is generated in the resource management capacity of the network, data is distributed and transmitted by activating both 5G access and Wi-Fi access, rather than data traffic is transmitted only via one of 5G access or Wi-Fi access.

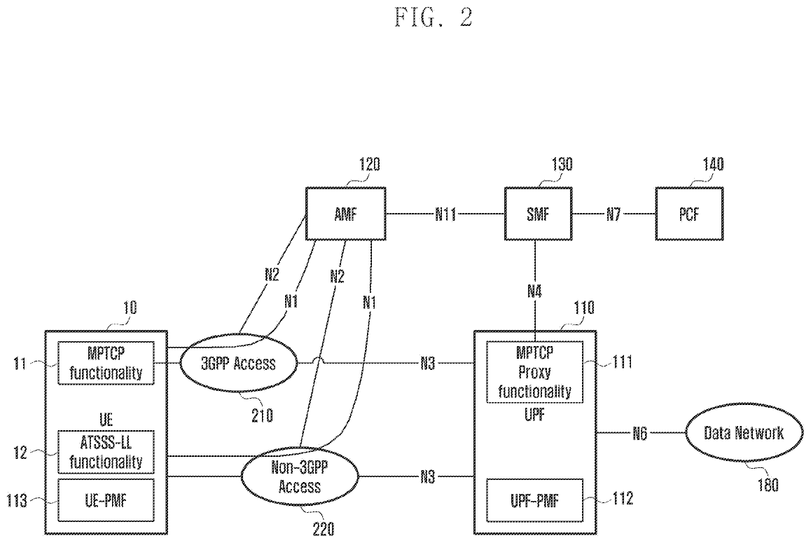

FIG. 2 illustrates an access traffic steering, switching, splitting (ATSSS) support structure in a 3GPP 5G system according to embodiments of the present disclosure.

Referring to FIG. 2, the UE 10 may access a mobile communication network, for example, a 3GPP access 210, and a non-mobile communication network, for example, a non-3GPP access 220. The ATSSS functionality may include steering functionality and steering mode.

The steering functionality may determine a transport protocol between the UPF of the transmitting device and the UPF of the receiving device. The steering functionality may be determined depending on a transport layer in which traffic steering, switching, and splitting are determined. When using the multi path TCP (MPTCP) (IETF RFC 8684) protocol located at a layer higher than a IP layer, the steering functionality may correspond to “MPTCP functionality,” and when the steering functionality is determined in a layer lower than the IP layer, the steering functionality may correspond to “ATSSS-lower layer (ATSSS-LL) functionality.” The UE may include MPTCP functionality 11 and ATSSS-LL functionality 12.

The UE and network supporting the MPTCP functionality may communicate with MPTCP proxy functionality 111 separately configured in the UPF 110. The MPTCP functionality may only control TCP traffic supporting the MPTCP protocol. When the ATSSS-LL functionality is supported, the MPTCP functionality may not include a separate proxy component in the UPF, and control all types of TCP traffic.

The steering mode defines a method for steering, switching, and splitting data traffic.

In addition, the UPF 110, the SMF 130, and the PCF 140 according to the disclosure may perform a separate control operation for access of the UE 10. This control operation will be further described with reference to drawings to be described later.

As illustrated in the drawing, the UPF 110 according to the disclosure may include MPTCP proxy functionality 111 therein.

The performance measurement function (PMF) is a function of measuring the network environment between the UE and UPF, and may measure round trip time (RTT) required for uplink and downlink, and whether 3GPP access and non-3GPP access are currently active. The steering functionality and steering mode which is able to be supported by the core network may be determined based on the information provided by the PMF, which has an overall effect on parameter determination for N3 and N4 connections. The PMF may be included in the UPF 110 and the UE 10, respectively. The PMF included in the UPF and the PMF included in the UE may be referred to as UPF-PMF 112 and UE-PMF 113, respectively.

As shown in FIG. 1, traffic may be transmitted via multipath between protocol data unit or packet data unit (PDU) session anchor user plane function (UPF) 110 and user equipment (UE) 10 when utilizing the ATSSS functionality described in FIG. 2.

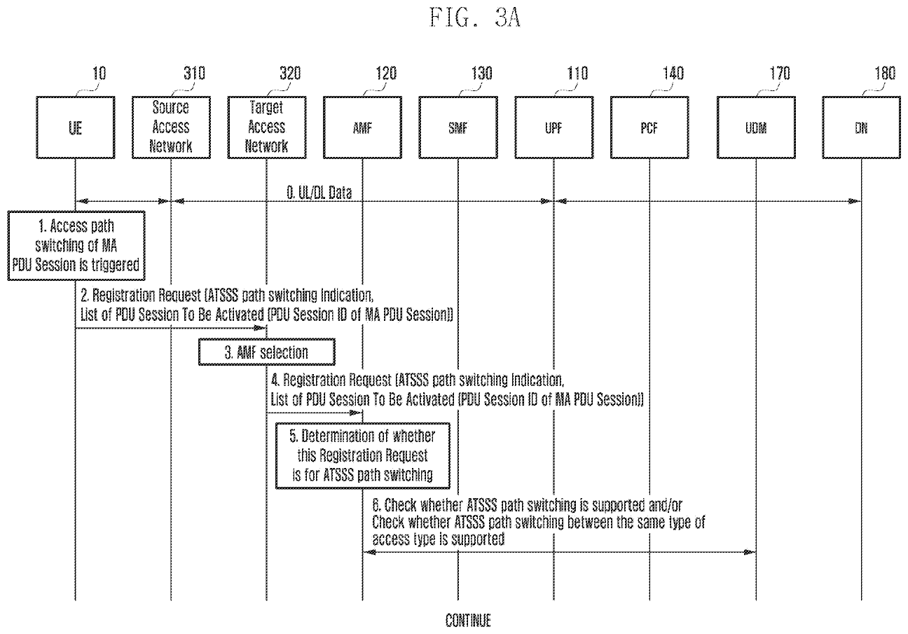

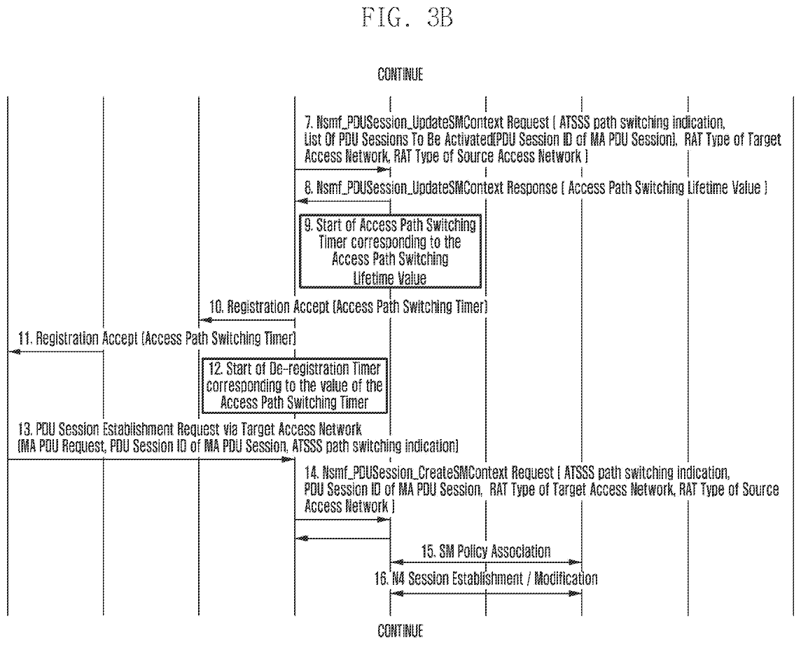

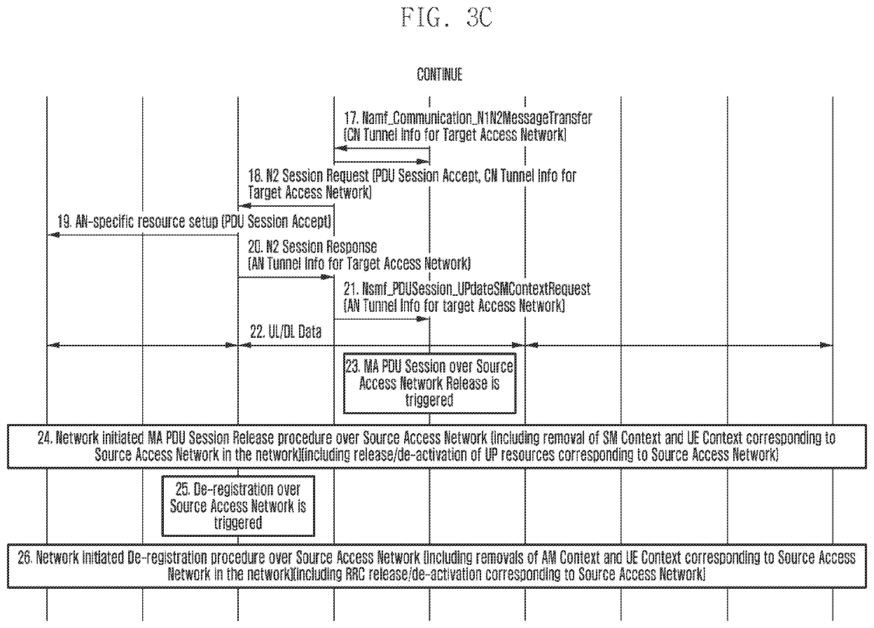

FIGS. 3A to 3C show a flowchart illustrating a method for switching an access path of the UE 10 in a wireless communication system and a procedure related thereto according to the disclosure.

Step 0: The UE 10 may transmit uplink data to the UPF 110 via a source access network 310. The UPF 110 may transport uplink data received from the UE 10 to the DN 180. The UPF 110 may transport downlink data received from the DN 180 to the UE 10 via the source access network 310.

Step 1: The UE 10 may determine to switch one access path among access paths using the MA PDU session. For example, when the UE 10 was using the MA PDU session including a 3GPP access path via a next generation radio access network (NG-RAN) and a non-3GPP access path via N3IWF, the UE 10 may determine to switch non-3GPP access path via N3WIF to the non-3GPP access path via TNGF. In this case, N3IWF may correspond to the source access network 310 and the TNGF may correspond to the target access network 320. As another example, the UE 10 may receive a request to switch one access path of access paths using the MA PDU session from the 5G core network (e.g., the SMF 130 and the AMF 120). A case in which the UE (10) or the 5G core network determines to switch the access path may include a case in which the UE 10 performs switching such that the non-3GPP access path is connectable directly to the HPLMN via TNGF, while the UE 10 is using the MA PDU session through an access path directly connected to HPLMN by the 3GPP access and an access path connected to HPLMN by non-3GPP access through N3IWF via SNPN network.

Step 2: The UE 10 may transmit a registration request message to the target access network 320. The registration request message may include at least one of an indication (e.g., an ATSSS switching indication) notifying access path switching of the MA PDU session and a PDU session ID of the MA PDU session. The PDU session ID of the MA PDU session may be included in the list of PDU session to be activated. The target access network 320 may receive a registration request message from the UE 10.

Step 3: The target access network 320 may select the same AMF 120 as the AMF 120 connected to the UE 10 such that the UE 10 uses the MA PDU session. For example, the target access network 320 may select the AMF 120, based on the registration request message received from the UE 10.

Step 4: The target access network 320 may transmit the registration request message received from the UE 10 to the AMF 120. The registration request message may include at least one of an indication (e.g., an ATSSS switching indication) notifying access path switching of the MA PDU session, and a PDU session ID of the MA PDU session. The PDU session ID of the MA PDU session may be included in the list of PDU session to be activated. The AMF 120 may receive a registration request message from the target access network 320.

Step 5: The AMF 120 may determine whether the registration request message received in step 4 is a request for access path switching of the MA PDU session. For example, when the AMF 120 receives an indication notifying access path switching of the MA PDU session and a list of PDU session to be activated, the AMF 120 may determine that the indication is a registration request for access path switching of the MA PDU session. As another example, the AMF 120 receives an indication notifying access path switching of the MA PDU session and/or a list of PDU session to be activated in a state in which the UE 10 has already been registered for an access type of the source access network 310, the AMF 120 may determine that the indication is a registration request for access path switching of the MA PDU session.

Step 6: The AMF 120 may acquire user subscription data of the UE 10 from the UDM 170 and determine whether the user is subscribed to access path switching function of the MA PDU session. Furthermore, the AMF 120 may acquire user subscription data of the UE 10 from the UDM 170 and determine whether the user is subscribed to a function of switching between the same access types for access path switching of the MA PDU session.

Step 7: When the AMF 120 determines in step 6 that the user is subscribed to the function of switching an access path of the MA PDU session and/or the function of switching between the same access types for access path switching of the MA PDU session, the AMF 120 may transmit a PDU session update request message to the SMF 130. The PDU session update request message may include an indication (e.g., an ATSSS switching indication) notifying access path switching of the MA PDU session, the PDU session of the MA PDU session, RAT type of target access network, and RAT type of source access network. The PDU session ID of the MA PDU session may be included in the list of PDU session to be activated. The SMF 130 may receive a PDU session update request message from the AMF 120.

Step 8: The SMF 130 may transmit a response message to the AMF 120 in response to the PDU session update request message. For example, the response message may include time (e.g., an access path switching lifetime value) required for access path switching.

Step 9: The SMF 130 may start an access path switching timer corresponding to time required for access path switching. The SMF 130 may determine that the access path is not switched when MA PDU session is not successfully established via the target access network 320 before the access path switching timer expires. For example, when AN tunnel Info of the target access network 320 is successfully received before the access path switching timer expires, the SMF 130 may determine that the access path has been successfully switched.

Step 10: The AMF 120 may evaluate whether the registration request of the UE 10 via the target access network 320 is valid and may perform a related procedure. The AMF 120 may transmit a registration accept message to the target access network 320. The registration accept message may indicate time required for access path switching or an access path switching timer. For example, the time required for access path switching or the access path switching timer value may be the same as or different from the time required for access path switching, received from the SMF 130 in step 8. The AMF 120 may prevent deregistration from starting while the UE 10 establishes an MA PDU session via the target access network 320 and switches an access path. For example, the AMF 120 may determine a value greater than the time required for access path switching, received from the SMF 130 in step 8 as an access path switching timer value. The target access network 320 may receive a registration accept message from the AMF 120.

Step 11: The target access network 320 may transmit the registration accept message received from the AMF 120 to the UE 10. The registration accept message may indicate time required for access path switching. The UE 10 may receive a registration accept message from the target access network 320.

Step 12: The AMF 120 may start a deregistration timer (e.g., a deregistration timer) corresponding to time required to switch a determined access path. The AMF 120 may determine that the access path is not switched when the MA PDU session is not successfully established via the target access network 320 until the registration deregistration timer expires. For example, when the AMF 120 receives a success response to the N2 PDU session request message from the target access network 320 before the deregistration timer expires, the AMF 120 may determine that the access path has been successfully switched.

Step 13: The UE 10 may transmit a PDU session establishment request message to the AMF 120 via the target access network 320. The PDU session establishment request message may include an indication notifying that the message is for the MA PDU session (e.g., MA PDU request) and the PDU session ID of the MA PDU session. The PDU session establishment request message may include an indication (e.g., an ATSSS path switching indication) notifying access path switching of the MA PDU session. The AMF 120 may receive a PDU session establishment request message from the UE 10 via the target access network 320.

Step 14: The AMF 120 may transmit an MA PDU session establishment request message requesting the SMF 130 to establish an MA PDU session via the target access network 320. The MA PDU session establishment request message may include an indication (e.g., an ATSSS switching indication) notifying access path switching of the MA PDU session, PDU session ID of the MA PDU session, RAT type of the target access network, and RAT Type of source access network. The SMF 130 may receive an MA PDU session establishment request message from the AMF 120.

The SMF 130 may transmit a response message in response to the MA PDU session establishment request message to the AMF 120. The SMF 130 may receive a response message in response to the MA PDU session establishment request message from the AMF 120.

Step 15: The SMF 130 may establish SM policy association for the MA PDU session via the PCF 140 and the target access network 320. For example, the SMF 130 may establish an SM policy association for the MA PDU session via the PCF 140 and the target access network 320, based on the MA PDU session establishment request message. SM policy association for the MA PDU session via the SMF 130 and the target access network 320 may be established by the PCF 140.

Step 16: An N4 session for an MA PDU session via the UPF 110 and the target access network 320 may be established by the SMF 130. At this time, the SMF 130 and/or the UPF 110 may generate CN tunnel information for the target access network 320. For example, the CN tunnel information may include an IP address and port number of the UPF 110 for N3 connection between the target access network 320 and the UPF 110.

Step 17: The SMF 130 may transmit a Namf_Communication_N1N2Message transfer message to the AMF 120. For example, the Namf_Communication_N1N2Message transfer message may include CN tunnel information for the target access network 320. The AMF 120 may receive the Namf_Communication_N1N2Message transfer message from the SMF 130.

The AMF 120 may transmit a response message in response to the Namf_Communication_N1N2Message transfer message to the SMF 130. The SMF 130 may receive a response message in response to the Namf_Communication_N1N2Message transfer message from the AMF 120.

Step 18: The AMF 120 may transmit an N2 session request message to the target access network 320. The N2 session request message may include a PDU session accept message and CN tunnel information for the target access network 320. The target access network 320 may receive an N2 session request message from the AMF 120.

Step 19: The target access network 320 may transmit an AN-specific resource setup message requesting AN-specific resource setup to the UE 10. The AN-specific resource setup message may include PDU session accept. The UE 10 may receive an AN-specific resource setup message from the target access network 320.

Step 20: The target access network 320 may transmit an N2 session response message to the AMF 120. The target access network 320 may generate AN tunnel information for the target access network 320. For example, the AN tunnel information may include an IP address and port number of the target access network 320 for N3 connection between the target access network 320 and the UPF 110. The N2 session response message may include AN tunnel information. The AMF 120 may receive the N2 session response message from the target access network 320.

Step 21: The AMF 120 may transmit an Nsmf_PDUSession_UPdateSMContext request message to the SMF 130. The Nsmf_PDUSession_UPdateSMContext request message may include AN tunnel information. The SMF 130 may receive the Nsmf_PDUSession_UPdateSMContext request message from the AMF 120.

Step 22: The UE 10 may transmit uplink data to the UPF 110 via the target access network 320. The UPF 110 may receive uplink data from UE 10 via the target access network 320. The UPF 110 may transmit uplink data received from the UE 10 to the DN 180. The DN 180 may receive uplink data from the UPF 110. The UPF 110 may transmit down link data to the DN 180. The UPF 110 may receive down link data from the DN 180. The UPF 110 may transmit down link data to the UE 10 via the target access network 320. The UE 10 may receive down link data from the UPF 110 via the target access network 320.

Step 23: When the SMF 130 receives AN tunnel information for the target access network 320 in step 21 and/or identifies that the MA PDU session has been successfully established via the target access network 320, the SMF 130 may determine access path release with respect to the source access network 310.

Step 24: An MA PDU session release procedure using the access path with respect to the source access network 310 may be performed. UE context and SM context related to the MA PDU session using the access path may be deleted from the related NF (the UE 10, the AMF 120, the SMF 130, the PCF 140, the UDM 170, etc.). User plane resources related to the MA PDU session using the access path with respect to the source access network 310 may be released.

Step 25: When the AMF 120 receives the AN tunnel information for the target access network 310 in step 20 and/or identifies that the MA PDU session has been successfully established via the target access network 310, the AMF 120 may determine deregistration of the UE 10 with respect to the source access network 310.

Step 26: A deregistration procedure of the UE 10 using the access path with respect to the source access network 310 may be performed. UE context and AM context related to the registration of the UE 10 using the access path with respect to the source access network 310 may be deleted from the related NF (the UE 10, the AMF 120, the SMF 130, the PCF 140, the UDM 170, etc.). RRC resources associated with registration of the UE 10 using the access path with respect to the source access network 310 may be released.

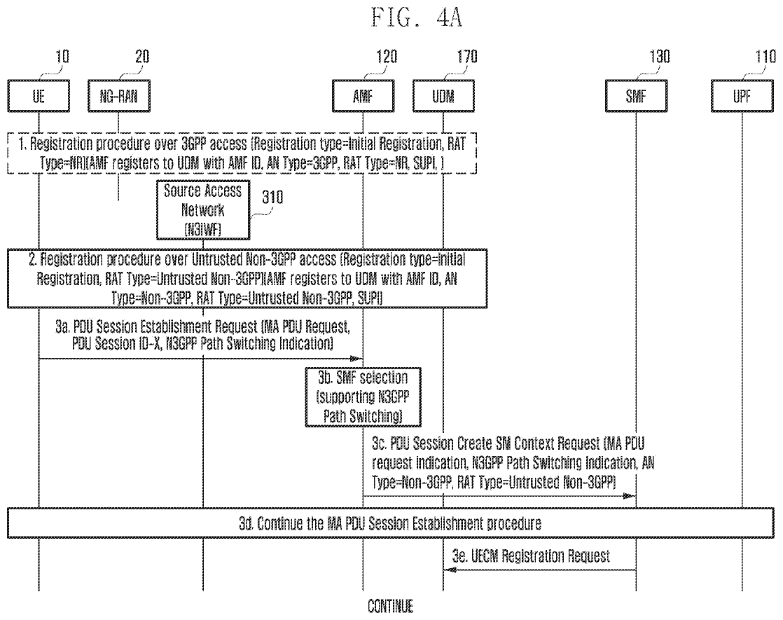

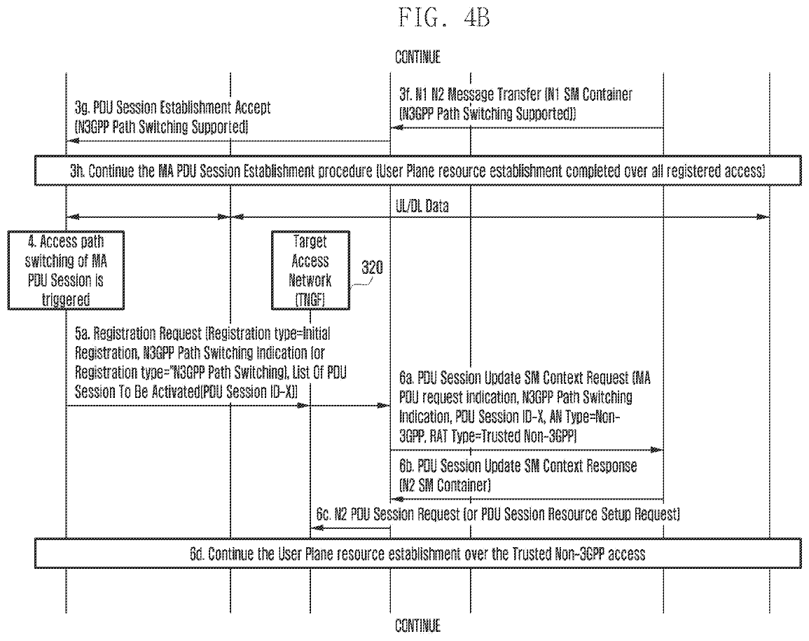

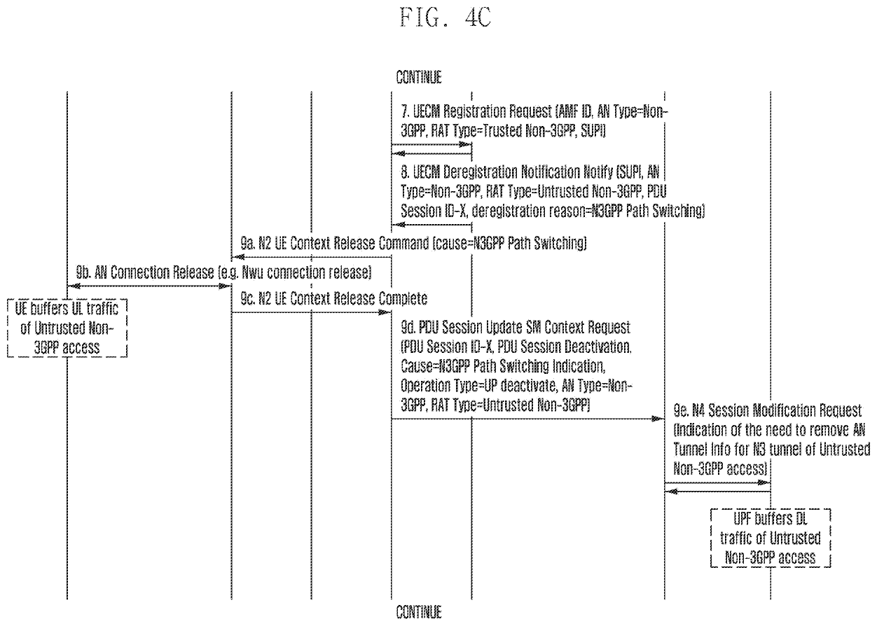

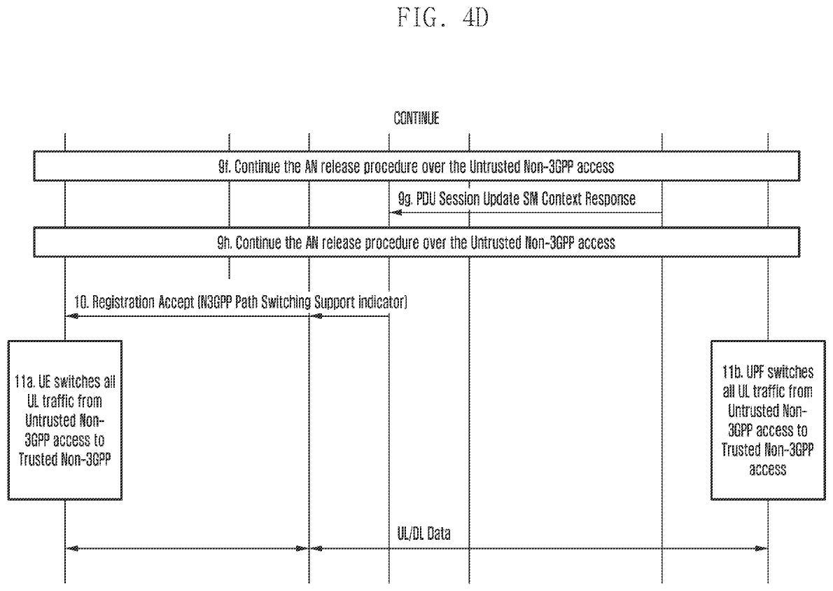

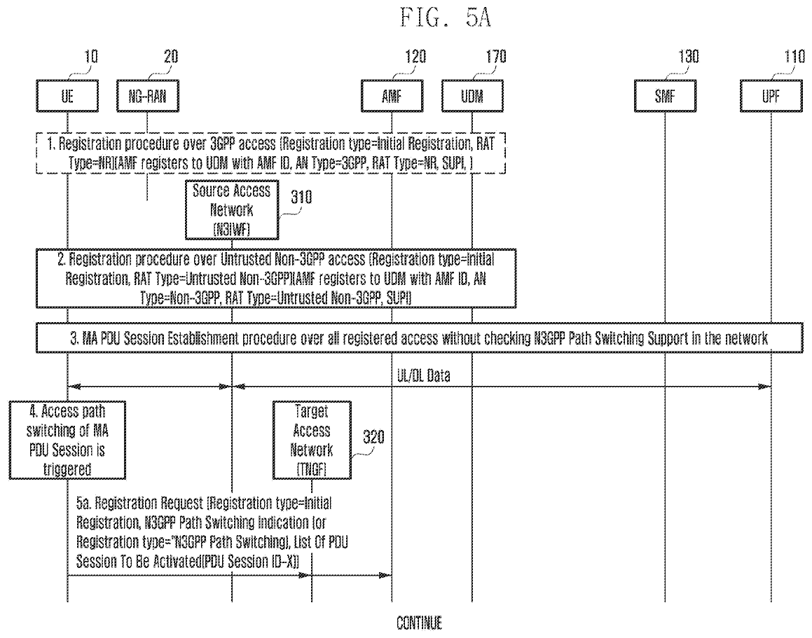

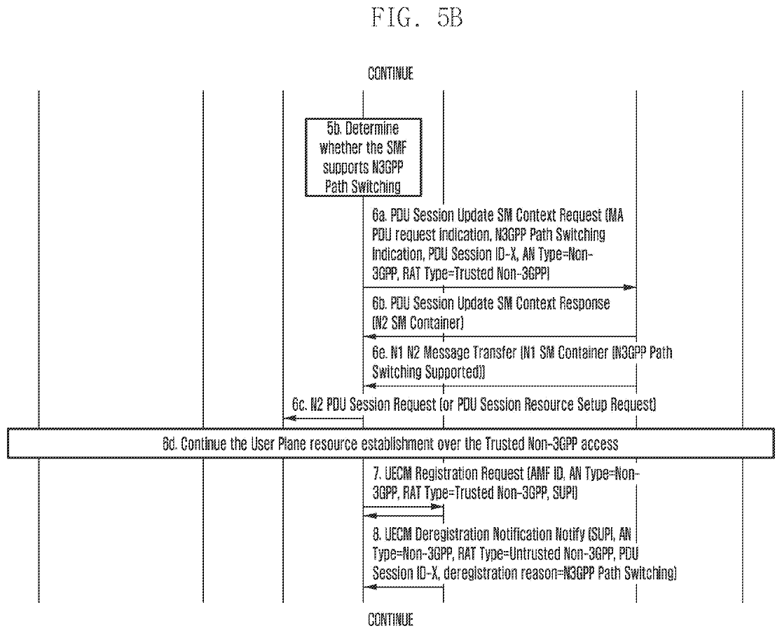

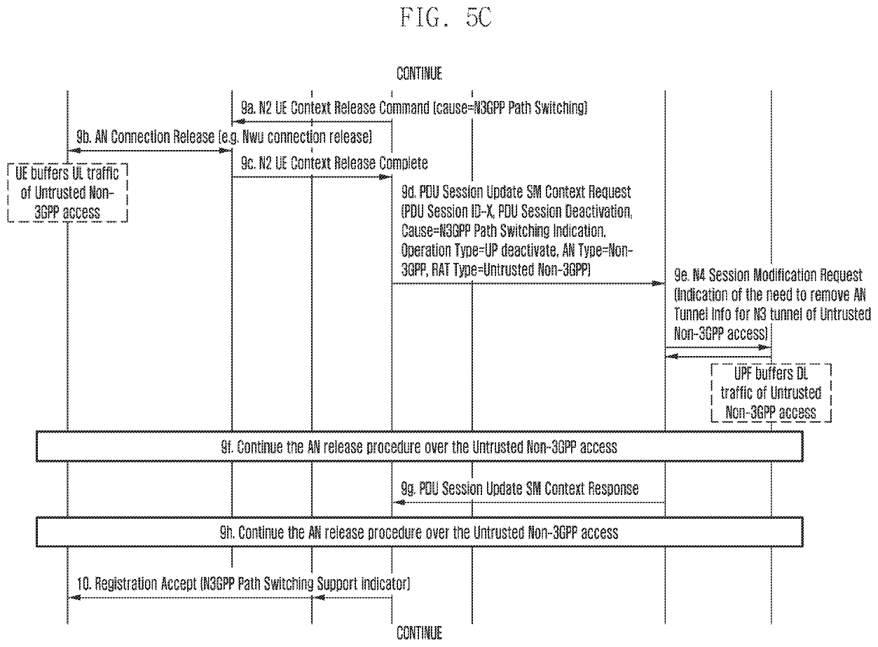

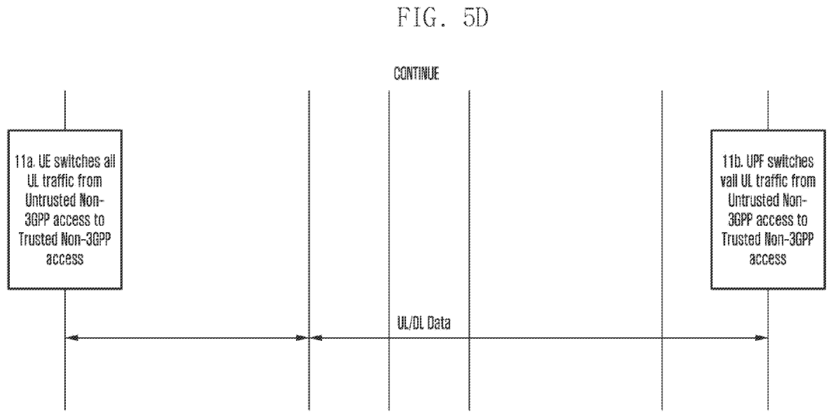

In FIGS. 4A to 4D and 5A to 5D, a case in which the UE 10 uses untrusted non-3GPP access using N3IWF as the source access network 310 for non-3GPP access, and uses trusted non-3GPP using TNGF as the target access network 320 will be described as an example. However, the same/similar method may also be applied to access path switching between different types of non-3GPP access (or 3GPP access to non-3GPP access, or vice versa), including a case in which source access network 310=trusted non-3GPP access to target access network 320=untrusted non-3GPP access, etc.

FIGS. 4A to 4D illustrates a flowchart of a method for switching an access path of the UE 10 in a wireless communication system and a procedure related thereto according to embodiments of the present disclosure.

Step 1: The UE 10 may perform a registration procedure with respect to 3GPP access by using the NG-RAN 20. For example, when the UE 10 transmits a request for registration to the AMF 120, the UE 10 may request initial registration of the registration type, and the AMF 120 may determine the RAT type as NR. In addition, the AMF 120 may provide an AMF ID (e.g., a GUAMI), 3GPP as AN type, NR as RAT type, and an SUPI to the UDM 170 in the UECM registration procedure (a procedure for registering the AMF 120 in the UDM 170 as a serving NF for the UE 10).

Step 2. The UE 10 may perform a registration procedure with respect to non-3GPP access by using the source access network 320. For example, when the UE 10 transmits a request for registration to the AMF 120, the UE 10 may request initial registration of the registration type, and the AMF 120 may determine the RAT type as untrusted non-3GPP. In addition, the AMF 20 provides an AMF ID (e.g., a GUAMI), non-3GPP as AN type, untrusted non-3GPP as RAT type, and an SUPI to the UDM 170 in the UECM registration procedure (a procedure for registering the AMF 120 in the UDM 170 as a serving NF for the UE 10).

Step 3a: The UE 10 may perform an MA PDU session establishment procedure with respect to non-3GPP access by using the source access network 310. For example, when the UE 10 transmits a PDU session establishment request to the AMF 120, the UE 10 may transmit at least one of MA PDU request (e.g., MA PDU request may be transmitted via a UL NAS transport message), PDU session ID=PDU session ID-X, and an indication (e.g., an N3GPP path switching indication) notifying non-3GPP access path switching of MA PDU session.

Step 3b: The AMF 120 may determine whether the AMF 120 supports non-3GPP access path switching and/or is able to manage one or more UE registration states and one or more UE connection states for the same access type. When the AMF 120 determines that the AMF 120 is unable to provide the support, the AMF 120 may reject PDU session establishment request from the UE 10.

The AMF 120 may select the SMF 130 that supports the non-3GPP access path switching function of the MA PDU session. When the AMF 120 is not allowed to select the SMF 130 supporting the non-3GPP access path switching function of the MA PDU session, the AMF 120 may reject the PDU session establishment request from the UE 10.

Step 3c: The AMF 120 may request the SMF 130 to generate a PDU session (e.g., the AMF 120 may transmit a PDU session create SM context request message to the SMF 130). The AMF 120 may transmit at least one of an MA PDU request indication, an N3GPP path switching indication, non-3GPP as AN type, and untrusted non-3GPP as RAT type to the SMF 130. When receiving the MA PDU request indication in step 3a, the AMF 120 may transmit the MA PDU request indication to the SMF 130. When receiving the N3GPP path switching indication in step 3a, the AMF 120 may transmit the N3GPP path switching indication to the SMF 130.

Step 3d: A procedure related to MA PDU session establishment is continuously performed. The related procedure may include allocation and provision of an IP address of the UE for a user plane via the source access network 310, and/or CN tunnel Info (the UPF-side N3 tunnel address), and/or AN tunnel Info (the source access network 310-side N3 tunnel address (e.g., IP address, UDP port, etc.)) with respect to the N3 tunnel connecting the source access network 310 and the UPF 110.

Step 3e: When the SMF 130 accepts the request for MA PDU session establishment supporting the N3GPP path switching function, the SMF 130 may transmit a UECM registration request to the UDM 170 (a procedure of registering the SMF 130 with the UDM 170 as serving NF for current UE 10 and current PDU session).

Step 3f: When the SMF 130 accepts the request for MA PDU session establishment supporting the N3GPP path switching function, the SMF 130 may transmit an indication (e.g., N3GPP path switching supported) notifying support of the N3GPP path switching function to the AMF 120. For example, the N3GPP path switching supported may be included in an N1 SM container and included in an N1 N2 message transfer message to be provided to the AMF 120.

Step 3g: The AMF 120 may transport a PDU session establishment accept message including N3GPP path switching supported to the UE 10.

Step 3h: A procedure related to the MA PDU session establishment is continuously performed. The related procedure may include user plane resource establishment for all access types in which the UE 10 is currently registered (e.g., AN tunnel Info, CN tunnel Info, and/or allocation and provision of an IP address of the UE 10 via the corresponding access network may be included for the N3 tunnel). When Step 3h is completed, the UE 10 may transmit and receive UL and/or DL data via the source access network 310.

Step 4: The UE 10 may determine to switch one access path among access paths using the MA PDU session. For example, the UE 10 may determine to switch the non-3GPP access path having used via N3IWF to another non-3GPP access path via TNGF.

Step 5a: The UE 10 may perform a registration procedure for non-3GPP access by using the target access network 320. For example, when the UE 10 transmits a request for registration to the AMF 120, the UE 10 may transmit at least one of initial registration of the registration type, an N3GPP path switching indication, and list of PDU session to be activated including the PDU session ID-X used as the MA PDU session ID in step 3a. As another example, when the UE 10 transmits a request for registration to the AMF 120, the UE 10 may transmit, as the registration type, at least one of N3GPP path switching, and the list of PDU session to be activated including the PDU session ID-X used as the MA PDU session ID in step 3a.

Step 6a: The AMF 120 may request the SMF 130 to update the MA PDU session (e.g., the AMF 120 may transmit a PDU session update SM context request message to the SMF 130). The AMF 120 may transmit at least one of an MA PDU request indication, an N3GPP path switching indication, PDU session ID=PDU session ID-X, non-3GPP as AN type, and trusted non-3GPP as RAT type to the SMF 130. When the AMF 120 determines that the registration request in step 5a is a request for switching the non-3GPP access path of the MA PDU session (e.g., including the case in which the N3GPP path switching indication is received in step 5a or registration type=N3GPP path switching is received in step 5a), the AMF 120 may transmit an N3GPP path switching indication to the SMF 130.

Step 6b: The SMF 130 may provide a response to the PDU session update request to the AMF 120. When the SMF 130 accepts the non-3GPP access path switching of the MA PDU session from the source access network 310 to the target access network 320, a procedure required for user plane resource establishment via the target access network 320 may be performed. For example, the procedure may include allocation and provision of an IP address of the UE for a user plane via the source access network 310, and/or CN tunnel Info (the UPF-side N3 tunnel address), and/or AN tunnel Info (the source access network 310-side N3 tunnel address (e.g., IP address, UDP port, etc.)) with respect to the N3 tunnel connecting the source access network 310 and the UPF 110. The SMF 130 may provide user plane resource information to be provided to the target access network 320 to the AMF 120 (e.g., may be included in an N2 SM container).

Step 6c: The AMF 120 may request the target access network 320 to set up a user plane resource related to the PDU session (e.g., an N2 PDU session request or PDU session resource setup request message may be transmitted).

Step 6d: A procedure required for user plane resource establishment via the target access network 320 may continuously performed by the AMF 120. For example, when allocation and provision of the IP address of the UE 10 for a user plane via the target access network 320 are performed in step 6b, the allocation and provision may be transported to the AMF 120. When step 6d is completed, the AMF 120 may recognize that the SMF 130 has accepted the non-3GPP access path switching of the MA PDU session from the source access network 310 to the target access network 320.

Step 7: The AMF 120 may notify the UDM 170 that the AMF 120 serves the UE 10 via the target access network 320. For example, the AMF 120 may provide the AMF ID (e.g., GUAMI), non-3GPP as AN type, trusted non-3GPP as RAT type, and SUPI to the UDM 170 in the UECM registration procedure.

Step 8: When the UDM 170 recognizes that the AMF 120 has performed UECM registration for the same AN Type (i.e., non-3GPP) with respect to the same UE 10 in step 7 (that is, in case of recognizing that AMF has registered with AN type=non-3GPP, RAT type=untrusted non-3GPP in step 2), the UDM 170 may notify the AMF 120 that the previous registration has been released (e.g., the UDM 170 may transmit a UECM deregistration notification notify message to the AMF 120). The UDM 170 may transmit at least one of SUPI, AN type=non-3GPP, RAT type=untrusted non-3GPP, PDU session ID=PDU session ID-X, and deregistration reason to the AMF 120. N3GPP path switching may be provided to the deregistration reason.

Step 9a: The AMF 120 may request the source access network 310 to release the UE context and/or release the AN connection. For example, the AMF 120 may transmit an N2 UE context release command message to the source access network 310, and N3GPP path switching may be provided to a cause.

Step 9b: The source access network 310 may request release of the AN connection to the UE 10. For example, the source access network 310 may perform a NWu connection release procedure.

The UE 10 may buffer (or may also drop) UL traffic to be transmitted via the source access network 310 after step 9b.

Step 9c: The source access network 310 may notify the AMF 120 that the release of the AN connection to the UE 10 has been completed. For example, the source access network 310 may transmit an N2 UE context release complete message to the AMF 120.

Step 9d: A request to release the non-3GPP access path via the source access network 310 of the MA PDU session may be provided by the AMF 120 to the SMF 130. To this end, the AMF 120 may request the SMF 130 to update the MA PDU session (e.g., the AMF 120 may transmit a PDU session update SM context request message to the SMF 130). The AMF 120 may transmit at least one of PDU session ID=PDU session ID-X, PDU session deactivation, cause, step type=UP deactivate, non-3GPP as AN type, and untrusted non-3GPP as RAT type to the SMF 130. The AMF 120 may use a cause value indicating release by non-3GPP access path switching. For example, the AMF 120 may use cause=N3GPP path switching indication.

Step 9e: A request to release user plane resources for a non-3GPP access path via the source access network 310 of the MA PDU session may be provided by the SMF 130. To this end, the SMF 130 may transmit an N4 session modification request to the UPF 110 (e.g., the SMF 130 may transmit an N4 session modification request to the N4). The SMF 130 may provide at least one of an indication notifying that removal of AN tunnel Info for the N3 tunnel of untrusted non-3GPP access is required (indication of the need to remove AN tunnel Info for N3 tunnel of untrusted non-3GPP access), AN tunnel Info for untrusted non-3GPP access, and CN tunnel Info for untrusted non-3GPP access to the UPF 110.

The UPF 110 may buffer DL traffic to be transmitted via the source access network 310 after step 9e (or may forward or drop traffic to the SMF 130).

Step 9f: A procedure related to AN release for the non-3GPP access path via the source access network 310 may be continuously performed by the SMF 130. Release of a session management policy related to the non-3GPP access path via the source access network 310 may be included in the related procedure.

Step 9g: A response to the user plane resource release request for the non-3GPP access path via the source access network 310 of the MA PDU session may be provided by the SMF 130 to the AMF 120.

Step 9h: A procedure related to AN release for the non-3GPP access path via the source access network 310 may be continuously performed by the AMF 120. Release of an access and mobility management policy related to a non-3GPP access path via the source access network 310 and/or a UE policy may be included in the related procedure.

Steps 9d to 9h (the core network-side user plane resource release and/or related policy release) may be performed prior to steps 9a to 9c and/or 9h (the access network and the UE 10-side user plane resource release and/or related policy release).

Step 10: The AMF 120 may transmit a registration accept message to the UE 10. The AMF 120 may inform the UE 10 that the non-3GPP access path switching function is supported in the core network. For example, the AMF 120 may transmit an N3GPP path switching support indication. Based on this indication, the UE 10 may determine whether the request for non-3GPP access path switching with respect to the same or new MA PDU session is allowed.

Step 11a: The UE 10 may transmit all UL traffic for the source access network 310 to the UPF 110 via the target access network 320.

Step 11b: The UPF 110 may transmit all DL traffic for the source access network 310 to the UE 10 via the target access network 320.

FIGS. 5A to 5D illustrate a flowchart of a method for switching an access path of the UE 10 in a wireless communication system and a procedure related thereto according to embodiments of the present disclosure.

Step 1: The UE 10 may perform a registration procedure for 3GPP access by using the NG-RAN 20. For example, when the UE 10 transmits a request for registration to the AMF 120, the UE 10 may request initial registration of the registration type, and the AMF 120 may determine the RAT type as NR. In addition, the AMF 120 may provide ID of the AMF 120 (e.g., GUAMI), 3GPP as AN type, NR as RAT type, and SUPI to the UDM 170 in the UECM registration procedure (a procedure for registering AMF 120 in the UDM 170 as serving NF for the UE 10).

Step 2: The UE 10 may perform a registration procedure for non-3GPP access by using the source access network 310. For example, when the UE 10 transmits a request for registration to the AMF 120, the UE 10 may request initial registration of the registration type, and the AMF 120 may determine the RAT type as untrusted non-3GPP. In addition, the AMF 120 may provide an AMF ID (e.g., GUAMI), non-3GPP as AN type, untrusted non-3GPP as RAT type, and SUPI to the UDM 170 in the UECM registration procedure (a procedure for registering the AMF 120 in the UDM 170 as serving NF for the UE 10).

Step 3: The UE 10 may perform an MA PDU session establishment procedure for non-3GPP access by using the source access network 310. At this time, the UE 10 may not provide an indication notifying that non-3GPP access path switching is supported. For example, when the UE 10 transmits a PDU session establishment request to the AMF 120, the UE 10 may transmit at least one of the MA PDU request (e.g., the MA PDU request may be transmitted via a UL NAS transport message) and PDU session ID=PDU session ID-X. In this case, the AMF 120 and the SMF 130 may not determine whether the AMF 120 and the SMF 130 themselves support non-3GPP access path switching and/or are able to manage one or more UE registration states and one or more UE connection states for the same access type.

When step 3 is completed, the UE 10 may transmit and receive UL and/or DL data via the source access network 310.

Step 4: The UE 10 may determine to switch one access path among access paths using the MA PDU session. For example, the UE 10 may determine to switch a non-3GPP access path having used via N3IWF to another non-3GPP access path via TNGF.

Step 5a: The UE 10 may perform a registration procedure for non-3GPP access by using the target access network 320. For example, when the UE 10 transmits a request for registration to the AMF 120, the UE may transmit, as the registration type, at least one of initial registration, an N3GPP path switching indication, and list of PDU session to be activated including PDU session ID-X used as the MA PDU session ID in step 3. As another example, when the UE 10 transmits a request for registration to the AMF 120, the UE may transmit, as the registration type, at least one of N3GPP path switching, and the list of PDU session to be activated including the PDU session ID-X used as the MA PDU session ID in step 3.

Step 5b: The AMF 120 may determine whether the AMF 120 supports non-3GPP access path switching and/or is able to manage one or more UE registration states and one or more UE connection states for the same access type. When the AMF 120 determines that the AMF 120 is unable to provide the support, the AMF 120 may reject the PDU session establishment request from the UE 10.

The AMF 120 may determine whether the SMF 130 supports non-3GPP access path switching function of the MA PDU session. When the SMF 130 does not provide the support, the AMF 120 may reject the PDU session establishment request from the UE 10.

Regardless of whether the AMF 120 and/or the SMF 130 support the non-3GPP access path switching function of the MA PDU session, when support of non-3GPP path switching function for the corresponding MA PDU session has not been identified (e.g., a case in which the SMF 130 and/or the AMF 120 has never received a PDU session establishment request including an N3GPP path switching indication for the corresponding MA PDU session may be included. As another example, a case in which the SMF 130 and/or the AMF 120 has never transmitted N3GPP path switching supported for the corresponding MA PDU session to the UE 10 may be included. As another example, a case in which the SMF 130 and/or the AMF 120 has not transmitted the N3GPP path switching support indication for the corresponding MA PDU session and the UE 10 may be included. The AMF 120 may reject the PDU session establishment request from the UE 10. At this time, for the rejection reason, the AMF 120 may notify the UE 10 that the non-3GPP path switching function is not providable.

Step 6a: The AMF 120 may request the SMF 130 to update the MA PDU session (e.g., the AMF 120 may transmit a PDU session update SM context request message to the SMF 130). The AMF 120 may transmit at least one of an MA PDU request indication, an N3GPP path switching indication, PDU session ID=PDU session ID-X, non-3GPP as AN type, and trusted non-3GPP as RAT type to the SMF 130. When the AMF 120 determines that the registration request in step 5a is a request for the non-3GPP access path switching of the MA PDU session (e.g., including a case in which the N3GPP path switching indication is received in step 5a or registration type=N3GPP path switching is received in step 5a), the AMF 120 may transmit an N3GPP path switching indication to the SMF 130.

Step 6b: The SMF 130 may provide a response to the PDU session update request to the AMF 120. When the SMF 130 accepts the non-3GPP access path switching of the MA PDU session from the source access network 310 to the target access network 320, a procedure necessary for user plane resource establishment via the target access network 320 may be performed by the SMF 130. For example, the procedure may include allocation and provision of an IP address of the UE for a user plane via the target access network 320, and/or CN tunnel Info (the UPF-side N3 tunnel address), and/or AN tunnel Info (the target access network 320-side N3 tunnel address (e.g., IP address, UDP port, etc.)) with respect to the N3 tunnel connecting the target access network 320 and the UPF 110. The SMF 130 may provide user plane resource information to be provided to the target access network 320 to the AMF 120 (e.g., may be included in the N2 SM container).

Step 6e: When the SMF 130 accepts the request for the MA PDU session establishment supporting the N3GPP path switching function, the SMF 130 may transmit an indication (e.g., N3GPP path switching supported) notifying the AMF 120 that the N3GPP path switching function is supported. For example, the N3GPP path switching supported may be included in the N1 SM container and included in an N1 N2 message transfer message to be provided to the AMF 120.

Step 6c: The AMF 120 may request the target access network 320 to set up a user plane resource related to the PDU session (e.g., the AMF 120 may transmit an N2 PDU session request or PDU session resource setup request message).

Step 6d: A procedure required for user plane resource establishment via the target access network 320 may be continuously performed by the SMF 130. For example, when allocation and provision of the IP address of the UE 10 for a user plane via the target access network 320 are performed in step 6b, the allocation and provision may be transported to the AMF 120. When step 6d is completed, the AMF 120 may recognize that the SMF 130 has accepted the non-3GPP access path switching of the MA PDU session from the source access network 310 to the target access network 320.

Step 7: The AMF 120 may notify the UDM 170 that the AMF 120 serves the UE 10 via the target access network 320. For example, AMF 120 may provide AMF ID (e.g., GUAMI), non-3GPP as AN type, trusted non-3GPP as RAT type, and SUPI to the UDM 170 in the UECM registration procedure.

Step 8: When the UDM 170 recognizes in step 7 that the AMF 120 has performed UECM registration for the same AN type (i.e., Non-3GPP) with respect to the same UE 10 (that is, in case of recognizing that the AMF 120 has registered with AN type=non-3GPP and RAT type=untrusted non-3GPP in step 2), the UDM 170 may notify the AMF 120 that the previous registration has been released (e.g., the UDM 170 may transmit a UECM deregistration notification notify message to the AMF 120). The UDM 170 may transmit at least one of SUPI, AN type=non-3GPP, RAT type=untrusted non-3GPP, PDU session ID=PDU session ID-X, and deregistration reason to the AMF 120. N3GPP path switching may be provided to the deregistration reason.

Step 9a: The AMF 120 may request the source access network 310 to release the UE context and/or release the AN connection. For example, the AMF 120 may transmit an N2 UE context release command message to the source access network 310, and N3GPP path switching may be provided to a cause.

Step 9b: The source access network 310 may request release of the AN connection to the UE 10. For example, the source access network 310 may perform a NWu connection release procedure.

The UE 10 may buffer (or may also drop) UL traffic to be transmitted via the source access network 310 after step 9b.

Step 9c: The source access network 310 may notify the AMF 120 that the release of the AN connection to the UE 10 has been completed. For example, the source access network 310 may transmit an N2 UE context release complete message to the AMF 120.

Step 9d: A request to release the non-3GPP access path via the source access network 310 of the MA PDU session may be provided by the AMF 120 to the SMF 130. To this end, the AMF 120 may request the SMF 130 to update the MA PDU session (e.g., the AMF 120 may transmit a PDU session update SM context request message to the SMF 130). The AMF 120 may transmit at least one of PDU session ID=PDU session ID-X, PDU session deactivation, cause, step type=UP deactivate, non-3GPP as AN type, and untrusted non-3GPP as RAT type to the SMF 130. The AMF 120 may use a cause value indicating release by non-3GPP access path switching. For example, the AMF 120 may use cause=N3GPP path switching indication.

Step 9e: A request to release user plane resources for a non-3GPP access path via the source access network 310 of the MA PDU session may be provided by the SMF 130. To this end, the SMF 130 may transmit an N4 session modification request to the UPF 110 (e.g., the SMF 130 may transmit an N4 session modification request to the N4). The SMF 130 may provide at least one of an indication notifying that removal of AN tunnel Info for the N3 tunnel of untrusted non-3GPP access is required (an indication of the need to remove AN tunnel Info for N3 tunnel of untrusted non-3GPP access), AN tunnel Info for untrusted non-3GPP access, and CN tunnel Info for untrusted non-3GPP access to the UPF 110.

The UPF 110 may buffer DL traffic to be transmitted via the source access network 310 after step 9e (or may forward or drop traffic to the SMF 130).

Step 9f: A procedure related to AN release for the non-3GPP access path via the source access network 310 may be continuously performed by the SMF 130. Release of a session management policy related to the non-3GPP access path via the source access network 310 may be included in the related procedure.

Step 9g: A response to the user plane resource release request for the non-3GPP access path via the source access network 310 of the MA PDU session may be provided by the SMF 130 to the AMF 120.

Step 9h: A procedure related to AN release for the non-3GPP access path via the source access network 310 may be continuously performed by the AMF 120. Release of an access and mobility management policy related to a non-3GPP access path via the source access network 310 and/or a UE policy may be included in the related procedure.

Steps 9d to 9h (the core network-side user plane resource release and/or related policy release) may be performed prior to steps 9a to 9c and/or 9h (the access network and the UE 10-side user plane resource release and/or related policy release).

Step 10: The AMF 120 may transmit a registration accept message to the UE 10. The AMF 120 may inform the UE 10 that the non-3GPP access path switching function is supported in the core network. For example, the AMF 120 may transmit an N3GPP path switching support indication. Based on this indication, the UE 10 may determine whether the request for non-3GPP access path switching with respect to the same or new MA PDU session is allowed.

Step 11a: The UE 10 may transmit all UL traffic for the source access network 310 to the UPF 110 via the target access network 320.

Step 11b: The UPF 110 may transmit all DL traffic for the source access network 310 to the UE 10 via the target access network 320.

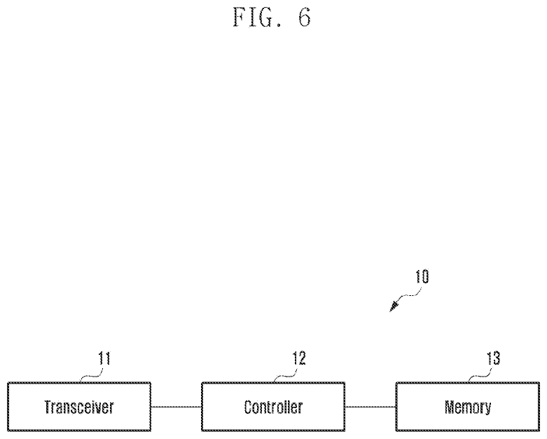

FIG. 6 illustrates the UE 10 in a wireless communication system according to embodiments of the present disclosure.

Referring to FIG. 6, the UE 10 according to the disclosure may include a controller 12 configured to control overall operations of the UE 10, a transceiver 11 including a transmitter and a receiver, and a memory 13. The disclosure is not limited to the above example, and the UE 10 may include more or fewer components than the components shown in FIG. 6. The UE 10 may be referred to as a terminal.

According to the disclosure, the transceiver 11 may transmit and receive signals to and from network entities 20, 310, 320, 120, 130, 110, 140, 170, and 180 or other UEs. Signals transmitted to and received from the network entities 20, 310, 320, 120, 130, 110, 140, 170, and 180 may include control information and data. In addition, the transceiver 11 may receive a signal via a wireless channel, output the signal to the controller 12, and transmit the signal output from the controller 12 via a wireless channel.

According to the disclosure, the controller 12 may control the UE 10 to perform the operations of FIGS. 3A to 5D described above. The controller 12, the memory 13, and the transceiver 11 do not necessarily have to be implemented as separate modules, but may also be implemented as a single component in the form of a single chip. In addition, the controller 12 and the transceiver 11 may be electrically connected to each other. In addition, the controller 12 may be an application processor (AP), a communication processor (CP), a circuit, an application-specific circuit, or at least one processor.

According to the disclosure, the memory 13 may store data such as a basic program for operation of the UE 10, an application program, and configuration information. In particular, the memory 13 provides stored data according to the request of the controller 12. The memory 13 may include a storage medium, such as a ROM, a RAM, a hard disk, a CD-ROM, and a DVD, or a combination of storage mediums. In addition, a plurality of memories 13 may be provided. In addition, the controller 12 may perform the above-described embodiments, based on a program for performing the above-described embodiments of the disclosure, stored in the memory 13.

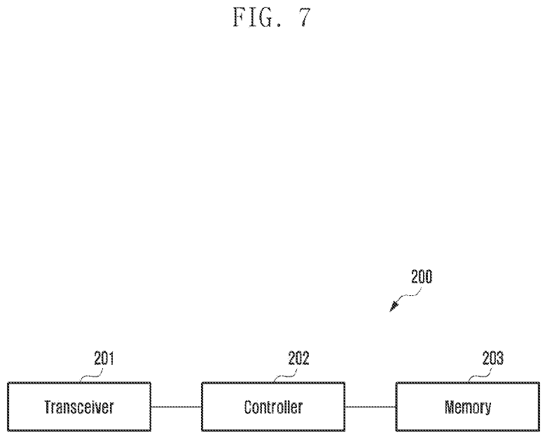

FIG. 7 illustrates the NR-RAN 20 in a wireless communication system according to embodiments of the present disclosure.

Referring to FIG. 7, the NR-RAN 20 according to the disclosure may include a controller 22 configured to control overall operations of the NR-RAN 20, a transceiver 21 including a transmitter and a receiver, and a memory 23. The disclosure is not limited to the above example, and the NR-RAN 20 may include more or fewer components than the components shown in FIG. 7.

According to the disclosure, the transceiver 21 may transmit and receive signals to and from network entities 310, 320, 120, 130, 110, 140, 170, and 180 or the UE 10. Signals transmitted to and received from the network entities 310, 320, 120, 130, 110, 140, 170, and 180 may include control information and data. In addition, the transceiver 21 may receive a signal via a wireless channel, output the signal to the controller 22, and transmit the signal output from the controller 22 via a wireless channel.

According to the disclosure, the controller 22 may control the NR-RAN 20 to perform the operations of FIGS. 3A to 5D described above. The controller 22, the memory 23, and the transceiver 21 do not necessarily have to be implemented as separate modules, but may also be implemented as a single component in the form of a single chip. In addition, the controller 22 and the transceiver 21 may be electrically connected to each other. In addition, the controller 22 may be an application processor (AP), a communication processor (CP), a circuit, an application-specific circuit, or at least one processor.

According to the disclosure, the memory 23 may store data, such as a basic program for operation of the NR-RAN 20, an application program, and configuration information. In particular, the memory 23 provides stored data according to the request of the controller 22. The memory 23 may include a storage medium, such as a ROM, a RAM, a hard disk, a CD-ROM, and a DVD, or a combination of storage mediums. In addition, a plurality of memories 23 may be provided. In addition, the controller 12 may perform the above-described embodiments, based on a program for performing the above-described embodiments of the disclosure, stored in the memory 23.

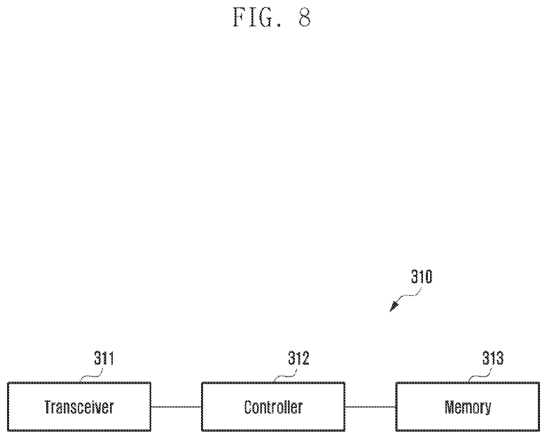

FIG. 8 illustrates the source access network 310 in a wireless communication system according to embodiments of the present disclosure.

Referring to FIG. 8, the source access network 310 according to the disclosure may include a controller 312 configured to control overall operations of the source access network 310, a transceiver 311 including a transmitter and a receiver, and a memory 313. The disclosure is not limited to the above example, and the source access network 310 may include more or fewer components than the components shown in FIG. 8.

According to the disclosure, the transceiver 311 may transmit and receive signals to and from at least of other network entities 20, 320, 120, 130, 110, 140, 170, and 180 or the UE 10. Signals transmitted to and received from at least one of the other network entities 320, 130, 120, 130, 110, 140, 170, and 180 or UE 10 may include control information and data.

According to the disclosure, the controller 312 may control the source access network 310 to perform the operations of FIGS. 3A to 5D described above. The controller 312, the memory 313, and the transceiver 311 do not necessarily have to be implemented as separate modules, but may also be implemented as a single component in the form of a single chip. In addition, the controller 312 and the transceiver 311 may be electrically connected to each other. In addition, the controller 312 may be an application processor (AP), a communication processor (CP), a circuit, an application-specific circuit, or at least one processor.

According to the disclosure, the memory 313 may store data such as a basic program for operation of the source access network 310, an application program, and configuration information. In particular, the memory 313 provides stored data according to the request of the controller 312. The memory 313 may include a storage medium, such as a ROM, a RAM, a hard disk, a CD-ROM, and a DVD, or a combination of storage mediums. In addition, a plurality of memories 313 may be provided. In addition, the controller 312 may perform the above-described embodiments, based on a program for performing the above-described embodiments of the disclosure, stored in the memory 313.

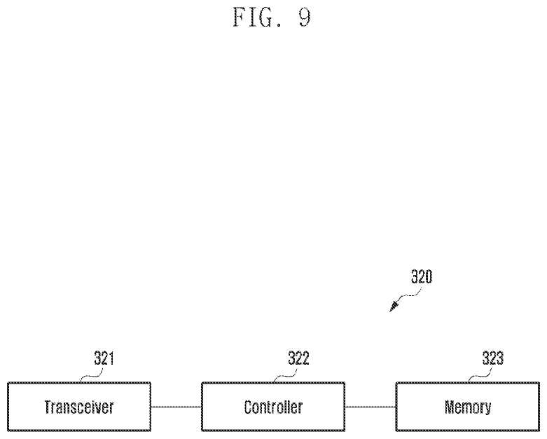

FIG. 9 illustrates the target access network 320 in a wireless communication system according to embodiments of the present disclosure.

Referring to FIG. 9, the target access network 320 according to the disclosure may include a controller 322 configured to control overall operations of the target access network 320, a transceiver 321 including a transmitter and a receiver, and a memory 323. The disclosure is not limited to the above example, and the target access network 320 may include more or fewer components than the components shown in FIG. 9.

According to the disclosure, the transceiver 321 may transmit and receive signals to and from at least of other network entities 20, 310, 120, 130, 110, 140, 170, and 180 or the UE 10. Signals transmitted to and received from at least one of the other network entities 20, 310, 120, 130, 110, 140, 170, and 180 or UE 10 may include control information and data.

According to the disclosure, the controller 322 may control the target access network 320 to perform the operations of FIGS. 3A to 5D described above. The controller 322, the memory 323, and the transceiver 321 do not necessarily have to be implemented as separate modules, but may also be implemented as a single component in the form of a single chip. In addition, the controller 322 and the transceiver 321 may be electrically connected to each other. In addition, the controller 322 may be an application processor (AP), a communication processor (CP), a circuit, an application-specific circuit, or at least one processor.

According to the disclosure, the memory 323 may store data such as a basic program for operation of the target access network 320, an application program, and configuration information. In particular, the memory 323 provides stored data according to the request of the controller 322. The memory 323 may include a storage medium, such as a ROM, a RAM, a hard disk, a CD-ROM, and a DVD, or a combination of storage mediums. In addition, a plurality of memories 323 may be provided. In addition, the controller 322 may perform the above-described embodiments, based on a program for performing the above-described embodiments of the disclosure, stored in the memory 323.

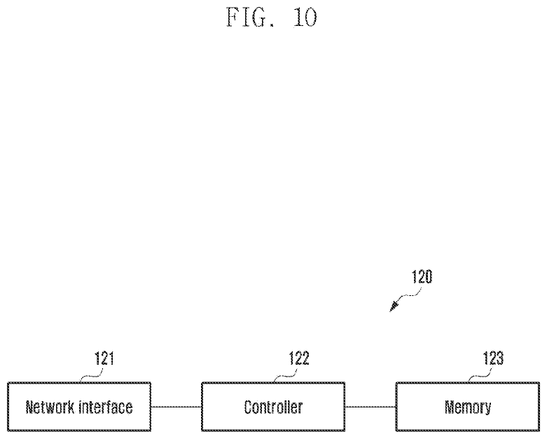

FIG. 10 illustrates the AMF 120 in a wireless communication system according to embodiments of the present disclosure.

Referring to FIG. 10, the AMF 120 according to the disclosure may include a controller 122 configured to control overall operations of the AMF 120, a network interface 121 including a transmitter and a receiver, and a memory 123. The disclosure is not limited to the above example, and the AMF 120 may include more or fewer components than the components shown in FIG. 10.

According to the disclosure, the network interface 121 may transmit and receive signals to and from at least of other network entities 310, 320, 130, 110, 140, 170, and 180 or the UE 10. Signals transmitted to and received from at least one of the other network entities 20, 310, 320, 130, 110, 140, 170, and 180 or UE 10 may include control information and data.

According to the disclosure, the controller 122 may control the AMF 120 to perform the operations of FIGS. 3A to 5D described above. The controller 122, the memory 123, and the network interface 121 do not necessarily have to be implemented as separate modules, but may also be implemented as a single component in the form of a single chip. In addition, the controller 122 and the network interface 121 may be electrically connected to each other. In addition, the controller 122 may be an application processor (AP), a communication processor (CP), a circuit, an application-specific circuit, or at least one processor.

According to the disclosure, the memory 123 may store data such as a basic program for operation of the AMF 120, an application program, and configuration information. In particular, the memory 123 provides stored data according to the request of the controller 122. The memory 123 may include a storage medium, such as a ROM, a RAM, a hard disk, a CD-ROM, and a DVD, or a combination of storage mediums. In addition, a plurality of memories 123 may be provided. In addition, the controller 122 may perform the above-described embodiments, based on a program for performing the above-described embodiments of the disclosure, stored in the memory 123.

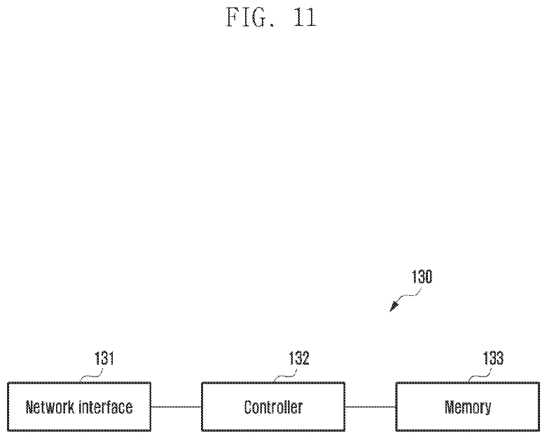

FIG. 11 illustrates the SMF 130 in a wireless communication system according to embodiments of the present disclosure.

Referring to FIG. 11, the SMF 130 according to the disclosure may include a controller 132 configured to control overall operations of the SMF 130, a network interface 131 including a transmitter and a receiver, and a memory 133. The disclosure is not limited to the above example, and the SMF 130 may include more or fewer components than the components shown in FIG. 11.

According to the disclosure, the network interface 131 may transmit and receive signals to and from at least of other network entities 20, 310, 320, 120, 110, 140, 170, and 180 or the UE 10. Signals transmitted to and received from at least one of the other network entities 20, 310, 320, 120, 110, 140, 170, and 180 or UE 10 may include control information and data.

According to the disclosure, the controller 132 may control the SMF 130 to perform the operations of FIGS. 3A to 5D described above. The controller 132, the memory 133, and the network interface 131 do not necessarily have to be implemented as separate modules, but may also be implemented as a single component in the form of a single chip. In addition, the controller 132 and the network interface 131 may be electrically connected to each other. In addition, the controller 132 may be an application processor (AP), a communication processor (CP), a circuit, an application-specific circuit, or at least one processor.

According to the disclosure, the memory 133 may store data such as a basic program for operation of the SMF 130, an application program, and configuration information. In particular, the memory 133 provides stored data according to the request of the controller 132. The memory 133 may include a storage medium, such as a ROM, a RAM, a hard disk, a CD-ROM, and a DVD, or a combination of storage mediums. In addition, a plurality of memories 133 may be provided. In addition, the controller 132 may perform the above-described embodiments, based on a program for performing the above-described embodiments of the disclosure, stored in the memory 133.

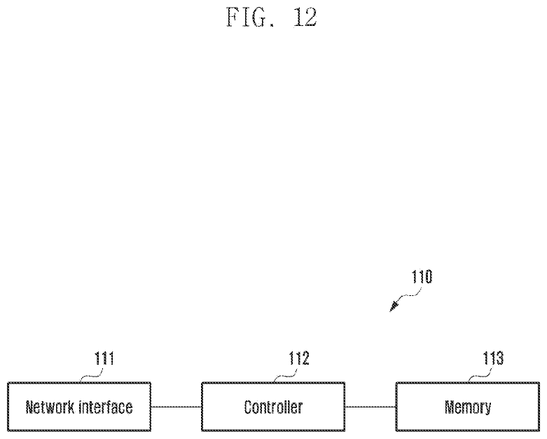

FIG. 12 illustrates the UPF 110 in a wireless communication system according to embodiments of the present disclosure.

Referring to FIG. 12, the UPF 110 according to the disclosure may include a controller 112 configured to control overall operations of the UPF 110, a network interface 111 including a transmitter and a receiver, and a memory 113. The disclosure is not limited to the above example, and the UPF 110 may include more or fewer components than the components shown in FIG. 12.

According to the disclosure, the network interface 111 may transmit and receive signals to and from at least of other network entities 20, 310, 320, 120, 130, 140, 170, and 180 or the UE 10. Signals transmitted to and received from at least one of the other network entities 20, 310, 320, 120, 130, 140, 170, and 180 or UE 10 may include control information and data.

According to the disclosure, the controller 112 may control the UPF 110 to perform the operations of FIGS. 3A to 5D described above. The controller 112, the memory 113, and the network interface 111 do not necessarily have to be implemented as separate modules, but may also be implemented as a single component in the form of a single chip. In addition, the controller 112 and the network interface 111 may be electrically connected to each other. In addition, the controller 112 may be an application processor (AP), a communication processor (CP), a circuit, an application-specific circuit, or at least one processor.

According to the disclosure, the memory 113 may store data such as a basic program for operation of the UPF 110, an application program, and configuration information. In particular, the memory 113 provides stored data according to the request of the controller 112. The memory 113 may include a storage medium, such as a ROM, a RAM, a hard disk, a CD-ROM, and a DVD, or a combination of storage mediums. In addition, a plurality of memories 113 may be provided. In addition, the controller 112 may perform the above-described embodiments, based on a program for performing the above-described embodiments of the disclosure, stored in the memory 113.

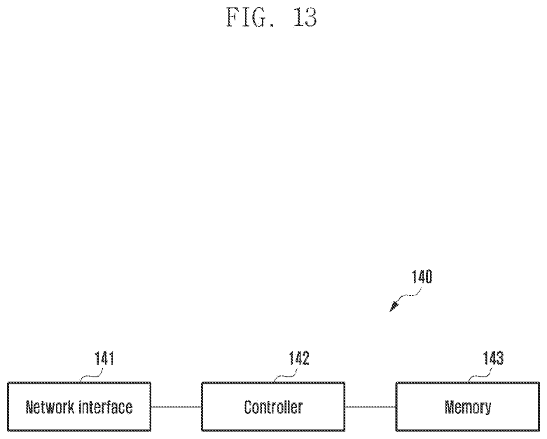

FIG. 13 illustrates the PCF 140 in a wireless communication system according to embodiments of the present disclosure.

Referring to FIG. 13, the PCF 140 according to the disclosure may include a controller 142 configured to control overall operations of the PCF 140, a network interface 141 including a transmitter and a receiver, and a memory 143. The disclosure is not limited to the above example, and the PCF 140 may include more or fewer components than the components shown in FIG. 13.

According to the disclosure, the network interface 111 may transmit and receive signals to and from at least of other network entities 20, 310, 320, 120, 130, 110, 170, and 180 or the UE 10. Signals transmitted to and received from at least one of the other network entities 20, 310, 320, 120, 130, 110, 170, and 180 or UE 10 may include control information and data.

According to the disclosure, the controller 142 may control the PCF 140 to perform the operations of FIGS. 3A to 5D described above. The controller 142, the memory 143, and the network interface 141 do not necessarily have to be implemented as separate modules, but may also be implemented as a single component in the form of a single chip. In addition, the controller 142 and the network interface 141 may be electrically connected to each other. In addition, the controller 142 may be an application processor (AP), a communication processor (CP), a circuit, an application-specific circuit, or at least one processor.

According to the disclosure, the memory 143 may store data such as a basic program for operation of the PCF 140, an application program, and configuration information. In particular, the memory 143 provides stored data according to the request of the controller 142. The memory 143 may include a storage medium, such as a ROM, a RAM, a hard disk, a CD-ROM, and a DVD, or a combination of storage mediums. In addition, a plurality of memories 143 may be provided. In addition, the controller 142 may perform the above-described embodiments, based on a program for performing the above-described embodiments of the disclosure, stored in the memory 143.

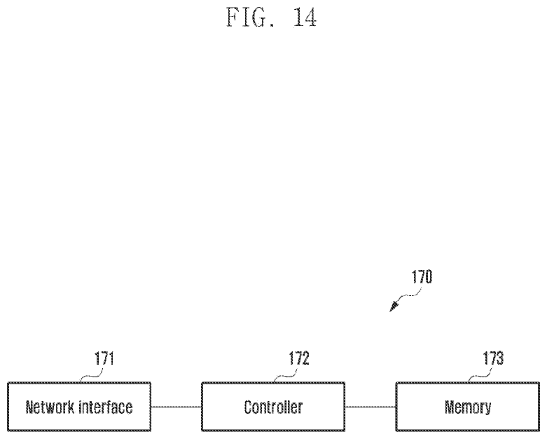

FIG. 14 illustrates the UDM 170 in a wireless communication system according to embodiments of the present disclosure.

Referring to FIG. 14, the UDM 170 according to the disclosure may include a controller 172 configured to control overall operations of the UDM 170, a network interface 171 including a transmitter and a receiver, and a memory 173. The disclosure is not limited to the above example, and the UDM 170 may include more or fewer components than the components shown in FIG. 14.

According to the disclosure, the network interface 171 may transmit and receive signals to and from at least of other network entities 20, 310, 320, 120, 130, 140, 110, and 180 or the UE 10. Signals transmitted to and received from at least one of the other network entities 20, 310, 320, 120, 130, 140, 110, and 180 or UE 10 may include control information and data.

According to the disclosure, the controller 172 may control the UDM 170 to perform the operations of FIGS. 3A to 5D described above. The controller 172, the memory 173, and the network interface 171 do not necessarily have to be implemented as separate modules, but may also be implemented as a single component in the form of a single chip. In addition, the controller 172 and the network interface 171 may be electrically connected to each other. In addition, the controller 172 may be an application processor (AP), a communication processor (CP), a circuit, an application-specific circuit, or at least one processor.

According to the disclosure, the memory 173 may store data such as a basic program for operation of the UDM 170, an application program, and configuration information. In particular, the memory 173 provides stored data according to the request of the controller 172. The memory 173 may include a storage medium, such as a ROM, a RAM, a hard disk, a CD-ROM, and a DVD, or a combination of storage mediums. In addition, a plurality of memories 173 may be provided. In addition, the controller 172 may perform the above-described embodiments, based on a program for performing the above-described embodiments of the disclosure, stored in the memory 173.

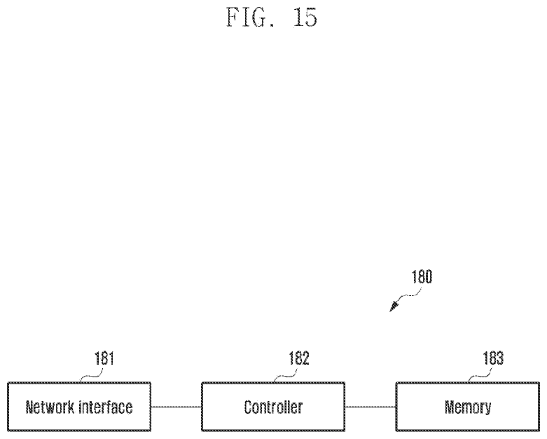

FIG. 15 illustrates the DN 180 in a wireless communication system according to embodiments of the present disclosure.

Referring to FIG. 15, the DN 180 according to the disclosure may include a controller 182 configured to control overall operations of the DN 180, a network interface 181 including a transmitter and a receiver, and a memory 183. The disclosure is not limited to the above example, and the DN 180 may include more or fewer components than the components shown in FIG. 15.

According to the disclosure, the network interface 181 may transmit and receive signals to and from at least of other network entities 20, 310, 320, 120, 130, 140, 110, and 170 or the UE 10. Signals transmitted to and received from at least one of the other network entities 20, 310, 320, 120, 130, 140, 110, and 170 or UE 10 may include control information and data.

According to the disclosure, the controller 182 may control the DN 180 to perform the operations of FIGS. 3A to 5D described above. The controller 182, the memory 183, and the network interface 181 do not necessarily have to be implemented as separate modules, but may also be implemented as a single component in the form of a single chip. In addition, the controller 182 and the network interface 181 may be electrically connected to each other. In addition, the controller 182 may be an application processor (AP), a communication processor (CP), a circuit, an application-specific circuit, or at least one processor.

According to the disclosure, the memory 183 may store data such as a basic program for operation of the DN 180, an application program, and configuration information. In particular, the memory 183 provides stored data according to the request of the controller 182. The memory 183 may include a storage medium, such as a ROM, a RAM, a hard disk, a CD-ROM, and a DVD, or a combination of storage mediums. In addition, a plurality of memories 183 may be provided. In addition, the controller 182 may perform the above-described embodiments, based on a program for performing the above-described embodiments of the disclosure, stored in the memory 183.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a user equipment (UE) in a wireless communication system, the method comprising:
transmitting, to a target access network, a registration request message comprising an access traffic steering, switching, splitting (ATSSS) path switching indication;
receiving, from the target access network, a registration accept message comprising an access path switching timer value from the target access network in response to the registration request message;
transmitting, to an access and mobility management function (AMF) via the target access network, a packet data unit (PDU) session establishment request message based on the access path switching timer value; and
releasing a PDU session with a source access network.

2. The method of claim 1, wherein the registration request message is transmitted, by the target access network, to a determined AMF.

3. The method of claim 2, wherein the registration accept message is transmitted to the target access network from the AMF.

4. The method of claim 3, wherein the registration accept message comprises, based on the registration request message, the access path switching timer value transmitted from a session management function (SMF) to the AMF.

5. The method of claim 4, wherein the access path switching timer value is transmitted from the SMF to the AMF in case that an access traffic steering, switching, splitting (ATSSS) path switching for the UE is supported based on the ATSSS path switching indication.

6. A method of an access and mobility management function (AMF) in a wireless communication system, the method comprising:
receiving, from a user equipment (UE) via a target access network, a registration request message comprising an access traffic steering, switching, splitting (ATSSS) path switching indication;
in case that an ATSSS path is switchable based on the registration request message, transmitting a packet date unit (PDU) session update request message indicating an ATSSS path switching indication, a radio access technology (RAT) type of the target access network, and a RAT type of a source access network to a session management function (SW);
receiving an update response message comprising an access path switching timer value from the SMF in response to the PDU session update request message;
transmitting, based on the update response message, a registration accept message comprising the access path switching timer value to the UE via the target access network; and
receiving, from the UE via the target access network, a PDU session establishment request message in response to the registration accept message.

7. The method of claim 6, further comprising transmitting a PDU session create request message to the SMF in response to the PDU session establishment request message.

8. The method of claim 7, wherein the PDU session create request message comprises the ATSSS path switching indication, the RAT type of the target access network, and the RAT type of the source access network.

9. The method of claim 6, further comprising starting, based on the access path switching timer value, a deregistration timer after transmitting the registration accept message.

10. The method of claim 9, comprising terminating a PDU session for the source access network in case that the deregistration timer expires or access network (AN) tunnel information is received from the UE before the deregistration timer expires.

11. A method of a session management function (SW) in a wireless communication system, the method comprising:
receiving a packet data unit (PDU) session update request message indicating an access traffic steering, switching, splitting (ATSSS) path switching indication of a user equipment (UE), a radio access technology (RAT) type of a target access network, and a RAT type of a source access network from an access management function (AMF);
transmitting a PDU session update response message comprising an access path switching timer value to the AMF in response to the PDU session update request message;
receiving, from the AMF, a PDU session create request message in response to the PDU session update response message; and
terminating, based on the PDU session create request message, a PDU session of the UE with respect to the source access network.

12. The method of claim 11, wherein the PDU session update request message is transmitted, from the AMF, based on a registration request message transmitted from the UE to the AMF, and
wherein the registration request message comprises an ATSSS path switching indication.

13. The method of claim 11, wherein the PDU session create request message comprises the ATSSS path switching indication, the RAT type of the target access network, and the RAT type of the source access network.

14. The method of claim 11, further comprising starting, based on the access path switching timer value, an access path switching timer after transmitting the PDU session update response message.

15. The method of claim 14, comprising terminating a PM session for the source access network in case that the access path switching timer expires, or access network (AN) tunnel information is received from the AMF before the access path switching timer expires.
